(19) United States
(12) Patent Application Publication
(10) Pub. No.: US 2023/0286113 A1
(43) Pub. Date: Sep. 14, 2023

(54) PIPE CLEANING TOOL

(71) Applicant: Robert Sean Schofield, Beeton (CA)

(72) Inventor: Robert Sean Schofield, Beeton (CA)

(21) Appl. No.: 17/692,302

(22) Filed: Mar. 11, 2022

(51) Int. Cl. B24D 13/02; B08B 9/023; B08B 9/02; B08B 9/045; B24D 13/10; B24D 13/20

(52) U.S. Cl. CPC B24D 13/02; B08B 9/023; B08B 9/021; B08B 9/045; B24D 13/10; B24D 13/20; B08B 2209/04

(57) ABSTRACT

A pipe cleaning tool is provided. A pipe cleaning tool, for preparing an exterior surface of a pipe and an interior surface of a fitting for joining the pipe to the fitting, comprising a central tubular member having a coupling member optionally coupled to a rotary tool. An interior pipe cleaner having a first polishing means surrounding an exterior of the interior pipe cleaner, the interior pipe cleaner coupled to a first end of the central tubular member and a tubular exterior pipe cleaner having a second polishing means surrounding an interior of an opened end of the tubular exterior pipe cleaner, the tubular exterior pipe cleaner coupled to a second end of the central tubular member.

### FIELD OF THE INVENTION

The present disclosure relates to a pipe cleaning tool, more specifically, but not by way of limitation, more particularly to a pipe cleaning tool that is optionally coupled to a pipe cutting tool for preparing an exterior surface of a copper pipe and an interior surface of a copper fitting for joining the pipe to the fitting.

### BACKGROUND

Any discussion of the related art throughout the specification should in no way be considered as an admission that such related art is widely known or forms part of common general knowledge in the field.

Currently, many polishing/cleaning tools exist within the plumbing/HVAC industries, which are required in order to remove debris and tarnish from the exterior surface of a pipe and from the interior of a fitting that will be subsequently fitted together. For example, multiple variations of handheld polishing tools exist that require the user to manually rotate the pipe and fitting in order to receive a desired polish, but these tools are often time consuming and exhausting for a user, especially when having to prepare a large quantity of pipes and fittings.

U. S. Pub. No. 2020/0353513 A1 (Cruz) discloses a manual pipe cleaning device for preparing the exterior of a pipe for soldering. Shortcomings include the manual operation of the device that is time consuming and exhausting for the user, an inability to polish the interior of a pipe or fitting, an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 6,357,119 B1 (Acerra) discloses a tube cutter/cleaner attachment which can be attached to a conventional tubing cutter. Shortcomings include an inability to polish the interior of a pipe or fitting, no mention of 3D printing any components for reducing manufacturing and purchasing costs and no mention of selecting compostable or biodegradable materials for any components which contributes waste to the environment.

U.S. Pat. No. 6,698,048 B1 (Greene) discloses a motorized device for cutting and cleaning a piece of pipe. Shortcomings include an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 6,704,964 B2 (Knowles) discloses a copper pipe cleaning assembly. Shortcomings include an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 6,813,797 B1 (Kadinger) discloses an adjustable fitting and pipe cleaning brush device. Shortcomings include the manual operation of the device that is time consuming and exhausting for the user, an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 7,743,510 B2 (Lazarevic) discloses a powered tool for tube cutting and treating. Shortcomings include an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 7,823,235 B2 (Parish) discloses a pipe cleaning tool adapted to clean at least two different sizes of pipes. Shortcomings include the manual operation of the device that is time consuming and exhausting for the user, an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 8,101,026 B1 (Brooks) discloses a copper pipe cleaner attachment for standard power dills. Shortcomings include an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 8,763,257 B2 (Thorson et al.) discloses a pipe cutter power tool. Shortcomings include an inability to polish the exterior or interior of a pipe or fitting, an inability to couple the device to an existing pipe cutting tool, no mention of 3D printing any components for reducing manufacturing and purchasing costs and no mention of selecting compostable or biodegradable materials for any components which contributes waste to the environment.

U.S. Pat. No. 10,507,569 B1 (Marotta) discloses a pipe-cleaning attachment. Shortcomings include an inability to couple the device to an existing pipe cutting tool, no mention of 3D printing any components for reducing manufacturing and purchasing costs and no mention of selecting compostable or biodegradable materials for any components which contributes waste to the environment.

All documents cited herein are incorporated by reference.

It is clear that there exists a need for a pipe cleaning tool for preparing an exterior surface of a copper pipe and an interior surface of a copper fitting for joining the pipe to the fitting. There is need for a pipe cleaning tool that is optionally coupled to a pipe cutting tool for reducing the amount of tools required and providing a cost effective solution to automating the polishing of pipes and fittings, that allows for straightforward assembly and replacement of the polishing means, provides a thorough and efficient polishing of pipes and fittings, that may be 3D printed to reduce manufacturing and purchasing costs and allows for the polishing means to be composed from compostable or biodegradable materials in order to provide a sustainable and environmentally friendly disposal of polishing means that degrade over time and may be replaced.

The disclosure proposes a pipe cleaning tool that is optionally coupled to a pipe cutting tool for preparing an exterior surface of a pipe and an interior surface of a fitting for joining the pipe to the fitting that overcomes disadvantages inherent in the existing pipe cleaning tools. The present invention provides a pipe cleaning tool that may be used with many different embodiments. As such, the general purpose of the present invention, which will be described subsequently in greater detail, is to provide a new and improved pipe cleaning tool for preparing an exterior surface of a pipe and an interior surface of a fitting for joining the pipe to the fitting, which provides the advantages and overcomes the aforementioned disadvantages.

### BRIEF SUMMARY

It is an object of the invention to provide a pipe cleaning tool.

In accordance with an aspect of the invention, there is provided a pipe cleaning tool comprising a central tubular member having a coupling member optionally coupled to a rotary tool. An interior pipe cleaner having a first polishing means surrounding an exterior of the interior pipe cleaner, the interior pipe cleaner coupled to a first end of the central tubular member and a tubular exterior pipe cleaner having a second polishing means surrounding an interior of an opened end of the tubular exterior pipe cleaner, the tubular exterior pipe cleaner coupled to a second end of the central tubular member.

In accordance with an embodiment of the invention, the interior pipe cleaner and the tubular exterior pipe cleaner are optionally fastened to the first end and the second end of the central tubular member.

In accordance with an embodiment of the invention, the interior pipe cleaner is permanently affixed to the first end of the central tubular member.

In accordance with an embodiment of the invention, the tubular exterior pipe cleaner is permanently affixed to the second end of the central tubular member.

In accordance with an embodiment of the invention, the first polishing means is a wire brush.

In accordance with an embodiment of the invention, the first polishing means is a sandpaper.

In accordance with an embodiment of the invention, the first polishing means is a steel wool.

In accordance with an embodiment of the invention, the second polishing means is a wire brush.

In accordance with an embodiment of the invention, the second polishing means is a sandpaper.

In accordance with an embodiment of the invention, the second polishing means is a steel wool.

In accordance with an embodiment of the invention, the central tubular member is manufactured via a 3D printer.

In accordance with an embodiment of the invention, the interior pipe cleaner is manufactured via a 3D printer.

In accordance with an embodiment of the invention, the tubular exterior pipe cleaner is manufactured via a 3D printer.

In accordance with an embodiment of the invention, the central tubular member, the interior pipe cleaner and the tubular exterior pipe cleaner are manufactured as a singular unit via a 3D printer.

In accordance with an embodiment of the invention, the one or more of the central tubular member, the interior pipe cleaner and the tubular exterior pipe cleaner are composed of plastic.

In accordance with an embodiment of the invention, the one or more of the central tubular member, the interior pipe cleaner and the tubular exterior pipe cleaner are composed of metal.

In accordance with an embodiment of the invention, the one or more of the central tubular member, the interior pipe cleaner and the tubular exterior pipe cleaner are composed of compostable materials.

In accordance with an embodiment of the invention, the one or more of the central tubular member, the interior pipe cleaner and the tubular exterior pipe cleaner are composed of biodegradable materials.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates a perspective view of a pipe cleaning tool, in accordance with one embodiment.

FIG. 2A illustrates a side view of a pipe cleaning tool, in accordance with one embodiment.

FIG. 2B illustrates a front view of a pipe cleaning tool, in accordance with one embodiment.

FIG. 2C illustrates a bottom view of a pipe cleaning tool, in accordance with one embodiment.

FIG. 2D illustrates a top view of a pipe cleaning tool, in accordance with one embodiment.

FIG. 3A illustrates a perspective view of a pipe cleaning tool, in accordance with one embodiment.

FIG. 3B illustrates an exploded view 300b of a pipe cleaning tool, in accordance with one embodiment.

FIG. 4A illustrates a perspective view of a pipe cleaning tool and pipe cutter, in accordance with one embodiment.

FIG. 4B illustrates a perspective view of a pipe cleaning tool and pipe cutter, in accordance with one embodiment.

FIG. 4C illustrates a perspective view of a pipe cleaning tool and pipe cutter, in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention provides a pipe cleaning tool that may be used with many different embodiments. As such, the general purpose of the present invention, which will be described subsequently in greater detail, is to provide a new and improved pipe cleaning tool that is optionally coupled to a pipe cutting tool for preparing an exterior surface of a pipe and an interior surface of a fitting for joining the pipe to the fitting, which provides the advantages and overcomes the aforementioned disadvantages.

After cutting the pipe or fitting, a user is required to remove debris and tarnish from the exterior surface of a pipe and from the interior of a fitting that will be subsequently fitted together such that the pipe is inserted into the fitting. Some methods for joining a pipe and fittings include, but are to limited to, adhesive bonding, brazing, corrugated stainless steel tubing coupling, flanging, grooving, heat-fusion welding, hubless coupling, mechanical coupling, cross-linked polyethylene coupling, pressing, quick connecting, soldering, solvent welding, threaded and welding or any other method for joining metals known in the art. to clean it in order to continue on to soldering the pipe.

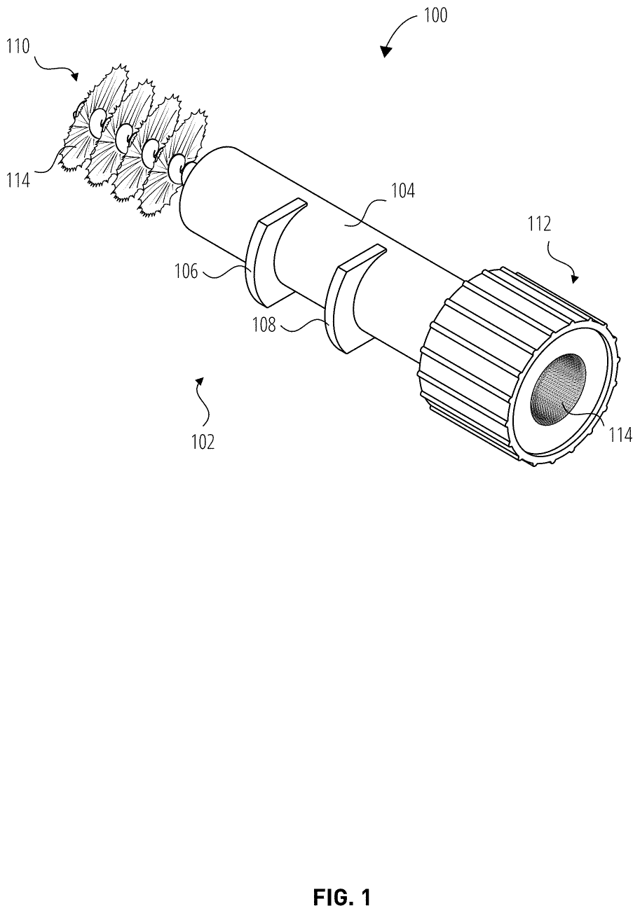

FIG. 1 illustrates a perspective view 100 of a pipe cleaning tool 102, according to some embodiments. The pipe cleaning tool 102 is shown comprising a central tubular member 104 having a coupling member, shown as first coupling member 106 and second coupling member 108, optionally coupled to a rotary tool. An interior pipe cleaner 110 is shown coupled to a first end of the central tubular member 104 and a tubular exterior pipe cleaner 112 is shown coupled to a second end of the central tubular member 104. The interior pipe cleaner 110 is shown having a first polishing means, bristles 114, surrounding an exterior of the interior pipe cleaner 110. The tubular exterior pipe cleaner 112 is shown having a second polishing means, also bristles 114 in this embodiment, surrounding an interior of an opened end of the tubular exterior pipe cleaner 112. In this embodiment, the pipe cleaning tool 102 is a unitary device.

In some embodiments, one or both of the first polishing means, and the second polishing means may be polishing apparatuses such as, but not limited to, a wire brush, sandpaper, steel wool or any other coated abrasives known in the art. In some embodiments, one or more of the pipe cleaning tool 102, the tubular exterior pipe cleaner 112 and the interior pipe cleaner 110 are manufactured as a singular unit via a 3D printer. In other embodiments, the central tubular member 104, the tubular exterior pipe cleaner 112 and the tubular interior pipe cleaner 110 are manufactured as a singular unit via a 3D printer. The 3D printing of the one or more components or the entirety of the pipe cleaning tool 102 allows for reduced manufacturing and purchasing costs.

In some embodiments, one or more of the central tubular member 104, the interior pipe cleaner 110 and the tubular exterior pipe cleaner 112, and their components, may be composed of materials such as, but not limited to, plastic, metal, compostable materials and biodegradable materials. Plastic and metal compositions provide durability for the pipe cleaning tool 102. Compostable and biodegradable compositions sustainable and environmentally friendly disposable solutions to replacing components of the pipe cleaning tool 102 that degrade over time. In some embodiments, the interior pipe cleaner 110 and/or the tubular exterior pipe cleaner 112 are permanently affixed to the first end and the second end of the central tubular member 104 respectively.

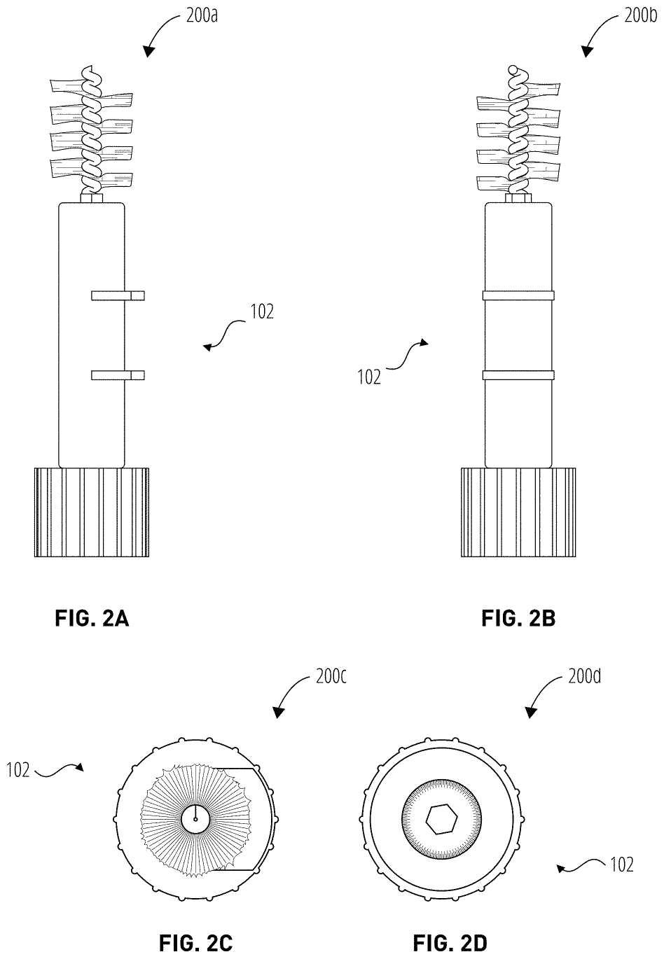

FIG. 2A illustrates a side view 200a of a pipe cleaning tool 102, according to some embodiments.

FIG. 2B illustrates a front view 200b of a pipe cleaning tool 102, according to some embodiments.

FIG. 2C illustrates a bottom view 200c of a pipe cleaning tool 102, according to some embodiments.

FIG. 2D illustrates a top view 200d of a pipe cleaning tool 102, according to some embodiments.

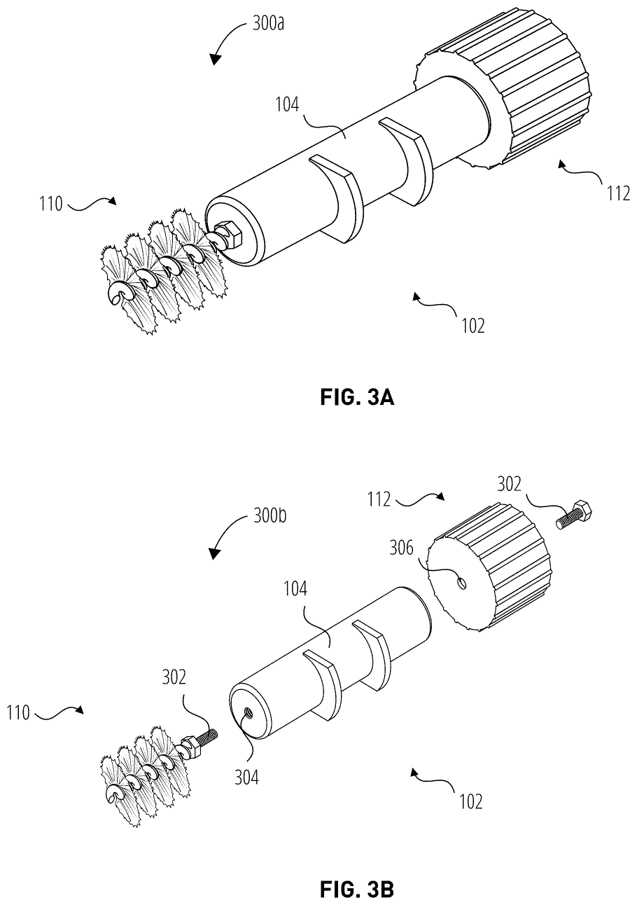

FIG. 3A illustrates a perspective view 300a of a pipe cleaning tool 102, according to some embodiments. In this embodiment, an interior pipe cleaner 110 is shown fastened to a first end of the central tubular member 104 while a tubular exterior pipe cleaner 112 is fastened to the second end of the central tubular member 104, such that the interior pipe cleaner 110 and the tubular exterior pipe cleaner 112 are on opposite ends of the central tubular member 104. In some embodiments, a wire mat may be inserted or is affixed to an opened end of the tubular exterior pipe cleaner 112, which is employed to clean the exterior of a pipe or fitting while the interior pipe cleaner 110, shown as a wire brush, is inserted or is affixed to the central tubular member 104 and may be inserted a the pipe or fitting to clean its interior.

FIG. 3B illustrates an exploded view 300b of a pipe cleaning tool 102, according to some embodiments. In this embodiment, the interior pipe cleaner 110 is coupled to a fastener 302 that is optionally fastened into a threaded hole 304 of the central tubular member 104 at a first end of the central tubular member 104, which affixes the interior pipe cleaner 110 to the central tubular member 104. At the second end of the central tubular member 104, the tubular exterior pipe cleaner 112 comprises a central aperture 306 which allows for a fastener 302 to piece through. The fastener 302 may be optionally fastened through the aperture 306 and into a threaded hole 304 of the central tubular member 104, which affixes the tubular exterior pipe cleaner 112 to the central tubular member 104.

In some embodiments, the interior pipe cleaner 110 is optionally coupled to the central tubular member 104 to accommodate for different pipe diameters such as, ⅜, ½, ¾ and 1″ and for replacement of polishing means and worn components as they wear over time. Similarly, the tubular exterior pipe cleaner 112 is optionally coupled to the central tubular member 104 to accommodate for different pipe diameters such as, ⅜, ½, ¾ and 1″ and for replacement of polishing means and worn components as they wear over time.

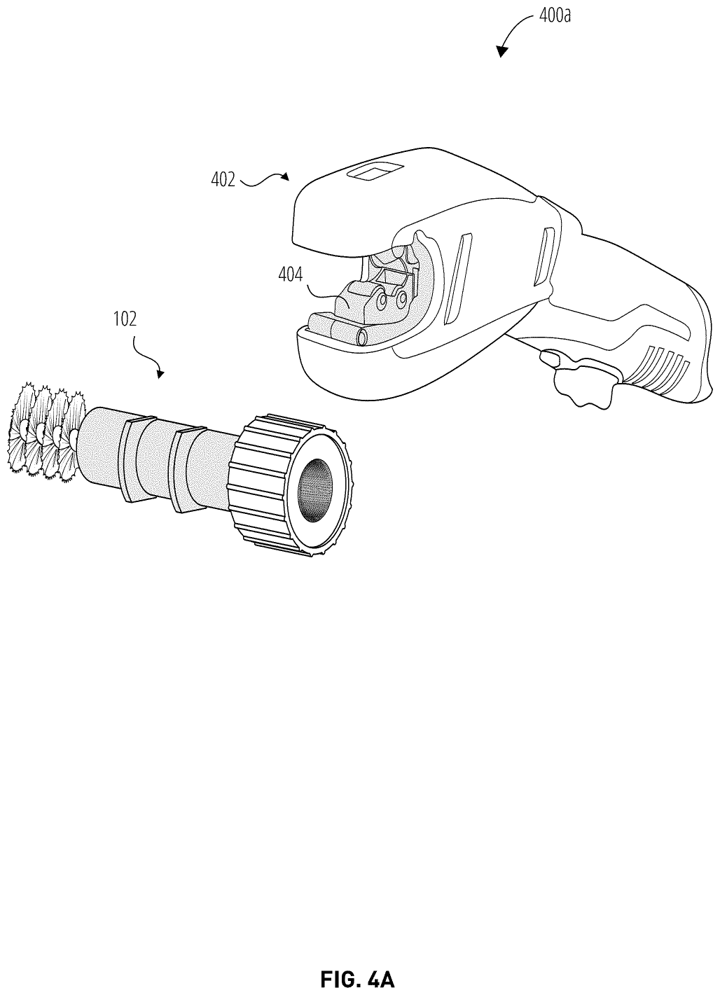

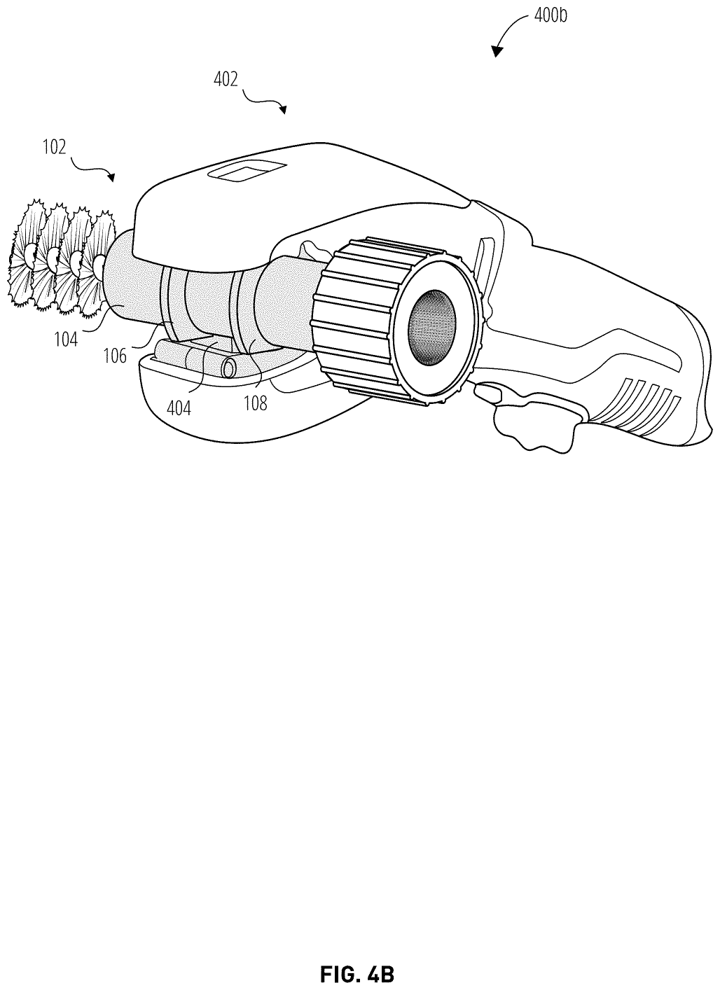

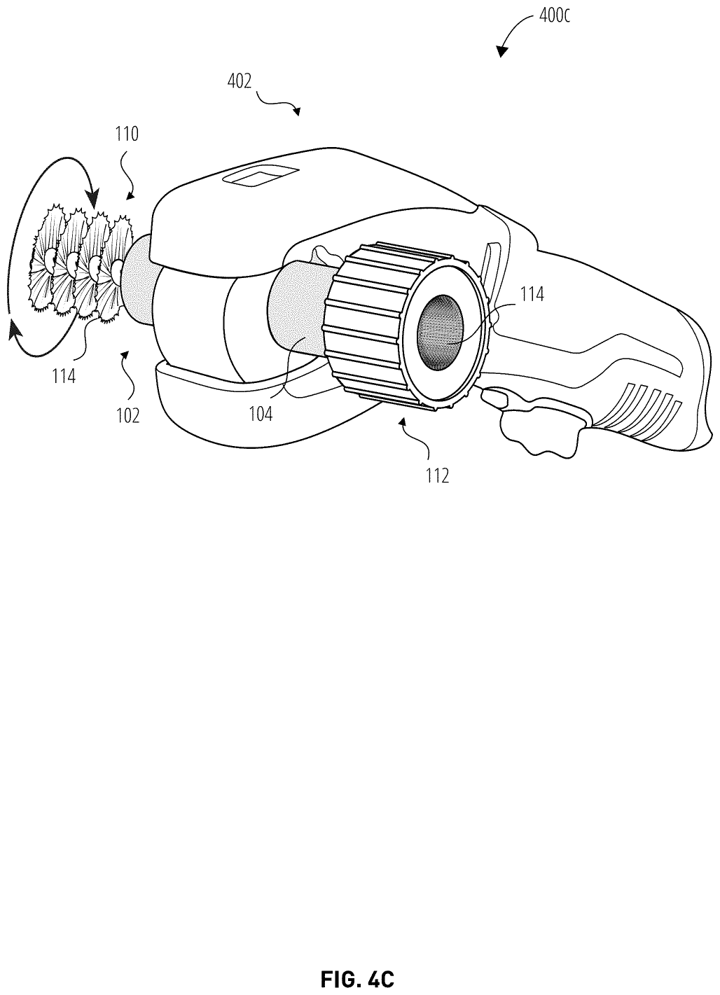

FIG. 4A illustrates a perspective view 400a of a pipe cleaning tool 102 and a pipe cutter 402, according to some embodiments. In this embodiment, an existing rotary tool, shown as a pipe cutter 402, is shown next to the pipe cleaning tool 102 where the pipe receiving member 404 portion of the pipe cutter 402 is visible. The pipe cleaning tool 102 may be optionally attached to the pipe cutter 402, as shown in FIG. 4B and FIG. 4C, in order to clean copper fittings and copper pipes for example.

By itself, the pipe cutter 402 is employed to for pipe cutting, which is essential prior to polishing and fitting of the pipes and fittings while polishing is typically accomplished via manual labor, which is a rather exhaustive and time-consuming task. By combining the pipe cleaning tool 102 to the pipe cutter 402, polishing of pipes, fittings, joints and the like can be reduced from minutes to seconds with confidence in the quality of the polishing, in repeated labor this time save accumulates into man hours saved.

FIG. 4B illustrates a perspective view 400b of a pipe cleaning tool 102 coupled to a pipe cutter 402, according to some embodiments. In this embodiment, the pipe cleaning tool 102 is coupled to the pipe receiving member 404 of the pipe cutter 402. This is accomplished by inserting the pipe cleaning tool 102 into the pipe receiving member 404 such that the first coupling member 106 and the second coupling member 108 engage and lock into the rotation mechanism of the pipe cutter 402. Once coupled, the central tubular member 104 rotates with the with the rotation mechanism of the pipe cutter 402, as shown in FIG. 4C.

FIG. 4C illustrates a perspective view 400c of a rotation of pipe cleaning tool 102 coupled to a pipe cutter 402 and, according to some embodiments. In this embodiment, the pipe cutter 402 is being powered to rotate the central tubular member 104 and subsequently rotating the interior pipe cleaner 110 and the tubular exterior pipe cleaner 112. During rotation, a pipe, fitting, or fastener may be inserted over the bristles 114 of the interior pipe cleaner 110 such that the bristles 114 contact and polish the interior of the pipe, fitting, or fastener. Likewise, during rotation, a pipe, fitting, or fastener may be inserted into the opening of the tubular exterior pipe cleaner 112 such that the bristles 114 contact and polish the exterior of the pipe, fitting, or fastener.

Employing the pipe cleaning tool 102 to an existing pipe cutter 402, such as a Milwaukee 12-volt cordless pipe cutter, reduces the number of tools required for a plumbing/HVAC tradesman while providing a cost-effective solution to automating the polishing of pipes and fittings, which provides a thorough and efficient polishing of pipes and fittings. Furthermore, assembly of the pipe cleaning tool 102 to the pipe cutter 402 is straightforward as well as replacement of the polishing means and other components.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A pipe cleaning tool, for preparing an exterior surface of a pipe and an interior surface of a fitting for joining said pipe to said fitting, comprising:
a central tubular member having a coupling member optionally coupled to a rotary tool;
an interior pipe cleaner having a first polishing means surrounding an exterior of said interior pipe cleaner, said interior pipe cleaner coupled to a first end of said central tubular member; and
a tubular exterior pipe cleaner having a second polishing means surrounding an interior of an opened end of said tubular exterior pipe cleaner, said tubular exterior pipe cleaner coupled to a second end of said central tubular member.

2. The pipe cleaning tool of claim 1, wherein said interior pipe cleaner and said tubular exterior pipe cleaner are optionally fastened to said first end and said second end of said central tubular member.

3. The pipe cleaning tool of claim 1, wherein said interior pipe cleaner is permanently affixed to said first end of said central tubular member.

4. The pipe cleaning tool of claim 1, wherein said tubular exterior pipe cleaner is permanently affixed to said second end of said central tubular member.

5. The pipe cleaning tool of claim 1, wherein said first polishing means is a wire brush.

6. The pipe cleaning tool of claim 1, wherein said first polishing means is a sandpaper.

7. The pipe cleaning tool of claim 1, wherein said first polishing means is a steel wool.

8. The pipe cleaning tool of claim 1, wherein said second polishing means is a wire brush.

9. The pipe cleaning tool of claim 1, wherein said second polishing means is a sandpaper.

10. The pipe cleaning tool of claim 1, wherein said second polishing means is a steel wool.

11. The pipe cleaning tool of claim 1, wherein said central tubular member is manufactured via a 3D printer.

12. The pipe cleaning tool of claim 1, wherein said interior pipe cleaner is manufactured via a 3D printer.

13. The pipe cleaning tool of claim 1, wherein said tubular exterior pipe cleaner is manufactured via a 3D printer.

14. The pipe cleaning tool of claim 1, wherein said central tubular member, said interior pipe cleaner and said tubular exterior pipe cleaner are manufactured as a singular unit via a 3D printer.

15. The pipe cleaning tool of claim 1, wherein one or more of said central tubular member, said interior pipe cleaner and said tubular exterior pipe cleaner are composed of plastic.

16. The pipe cleaning tool of claim 1, wherein one or more of said central tubular member, said interior pipe cleaner and said tubular exterior pipe cleaner are composed of metal.

17. The pipe cleaning tool of claim 1, wherein one or more of said central tubular member, said interior pipe cleaner and said tubular exterior pipe cleaner are composed of compostable material.

18. The pipe cleaning tool of claim 1, wherein one or more of said central tubular member, said interior pipe cleaner and said tubular exterior pipe cleaner are composed of biodegradable material.
